(19) United States
(12) Patent Application Publication
(10) Pub. No.: US 2012/0148996 A1
(43) Pub. Date: Jun. 14, 2012

(54) METHOD FOR FACILITATING THE IDENTIFICATION OF SUITABLE OBJECT-WIPING MATERIAL AND DISPENSER THEREFOR

(75) Inventors: Stefan Henricson, Askim (SE); Karin Öjersjö, Goteborg (SE); Anders Hellqvist, Goteborg (SE); Giovanni Benedetti, Scotland (GB); Malin Andersson, Hovas (SE); Björn Larsson, Billdal (SE)

(73) Assignee: SCA Hygiene Products AB, Goteborg (SE)

(21) Appl. No.: 13/379,733

(22) PCT Filed: Jun. 11, 2010
(86) PCT No.: PCT/SE2010/050658

§ 371 Date: Dec. 21, 2011

(30) Foreign Application Priority Data
Jun. 30, 2009 (SE) 0950509-0

(51) Int. Cl. G09B 3/00

(52) U.S. Cl. 434/322

(57) ABSTRACT

A method for facilitating the identification of suitable object-wiping material and dispenser (10) therefor. The method includes the steps of: providing a questionnaire (50) with a plurality of questions (52, 54, 56), at least one (52, 56) of the plurality of questions relating to user requirements of the object-wiping material and at least a further (54) of the plurality of questions relating to the work situation of the user; providing for each question an exhaustive list of possible answers from which the user is to select at least one, and depending on the selected answers, providing a recommendation (58) of the type of object-wiping material and dispenser most suited to that user's needs.

### CROSS-REFERENCE TO RELATED APPLICATIONS

This application is a National Phase Entry of International PCT patent application No. PCT/SE2010/050658, filed on Jun. 11, 2010, and which claims the benefit of priority based on Swedish patent application No. SE 0950509-0, filed Jun. 30, 2009. The contents of each of PCT/SE2010/050658 and SE 0950509-0 are expressly incorporated herein by reference in their entirety.

### TECHNICAL FIELD

The present invention relates to a method for facilitating the identification of suitable object-wiping material and dispenser therefor.

### BACKGROUND OF THE INVENTION

The manufacturing, HoReCa (Hotel, restaurant, catering), healthcare and servicing/repair industries are highly reliant on wiping material such as paper and nonwoven for preparing and cleaning surfaces. These surfaces may be on components which are manufactured or repaired, equipment which is used for manufacturing or repair, surfaces on which foodstuff is prepared or floors upon which equipment stands. The wiping material is normally housed in a suitable dispenser at a location which is convenient for the particular surface.

Generally, a particular type of wiping material is associated with each specific wiping application. For example, for preparing a highly polished surface it is common to utilize a soft low-linting cloth, whilst for e.g. an oil spillage it is common to use a material with good absorption properties. Since a particular type of wiping material may be associated with a specific wiping application and each type of wiping material has dedicated properties, each type of wiping material format, e.g. roll, cut wipers, etc., normally has a dispenser which is specially adapted to that type of wiping material format, including the volume of wiping material needed.

“Cost-in-use” is a very important factor when choosing the supplier of object-wiping system. A customer is generally more interested in the total costs over, for example, a five year period than the initial procurement cost. To optimize the cost-in-use, it is essential that the customer acquires the most suitable product or products for his or her needs. For example, it makes little economic sense to use a polishing cloth to mop up an oil spillage. A further important factor is the expected consumption rate of the object-wiping material. After all, a one-man sandwich bar operation will consume much less object-wiping material than a kitchen supplying hospitals and schools.

There is a myriad of different object-wiping materials and associated dispensers on the market. Whilst, in theory at least, this means that an individual user is able to acquire the most suitable object-wiping material and dispenser for a particular application, the most appropriate material and dispenser are often hidden among the huge choice.

Since, for each wiping application, there is a particular wiping material which is most suitable, and an appropriate dispenser is required for that wiping material, a workshop in which several activities take place may need several different types of wiping material and associated dispensers.

It is therefore an object of the present invention to provide a method for facilitating the identification of suitable object-wiping material and dispenser therefor. It is a further object to provide a method in which, irrespective of his/her selection of object-wiping material and dispenser, the user is ensured that the selected dispenser will bear a distinctive family trait.

### SUMMARY OF THE INVENTION

One or more of the above objects is achieved in accordance with the present invention by a method for facilitating the identification of suitable object-wiping material and dispenser therefor, the method comprising the steps of
providing a questionnaire with a plurality of questions, at least one of said plurality of questions relating to user requirements of the object-wiping material and at least a further of said plurality of questions relating to the work situation of the user;
providing for said at least one of said plurality of questions and said at least a further of said plurality of questions, respectively, an exhaustive list of possible answers from which the user is to select at least one, and
   depending on the selected answers, providing a recommendation of the type of object-wiping material and dispenser most suited to that user's needs.

The method may be performed by a potential purchaser of object-wiping material or by a sales person in collaboration with a potential purchaser. The questionnaire utilized in the method may suitably be printed in paper format, such as a folder. Alternatively, the questionnaire utilized in the method may suitably be integrated in software which can be run on a computer such as a PC and/or on line via, for example, the internet. By providing for each question an exhaustive list of possible answers, the person completing the questionnaire is provided with prompts, thereby facilitating the completion of the questionnaire. Since the method provides a recommendation of the type of object-wiping material and dispenser most suited to the user's needs, the risk of selecting an inappropriate object-wiping material and dispenser, both from a function and cost perspective, is reduced. This is particularly the case if the recommendation is a single recommendation.

According to one aspect of the invention, the method comprises the step of
providing a wiping material system comprising a plurality of dispensers of different shapes and/or sizes, the dispensers each comprising at least a first and a second component, said first and second components being visible to a user, said first component being of a first colour and said second component being of a second colour, said first and second colours being distinct from each other, wherein the colour of said first component and the colour of said second component are identical for all dispensers of said plurality of dispensers, and
   said step of providing a recommendation of the type of object-wiping material and dispenser most suited to that user's needs includes recommending one of said plurality of dispensers of said wiping material system.

As a result of this method, irrespective of his or her choice, the user can be secure in the knowledge that the recommended dispenser will visually pass in with any other dispenser from the wiping material system. Thus, even if a customer needs different wiping material for several different applications, and therefore must acquire several different dispensers, all the dispensers will enjoy a common identity.

Further aspects of the method of the present invention are detailed in the appended dependent claims.

### BRIEF DESCRIPTION OF THE DRAWINGS

The invention will be described in the following by way of example only and with reference to the attached drawings in which:

FIG. 1 is a schematic perspective view of a first dispenser of a wiping material system comprising a plurality of dispensers of different shapes and/or sizes for use in the method of the present invention;

FIG. 2 is a schematic perspective view of a second dispenser of the wiping material system for use in the method of the present invention;

FIG. 3 is a schematic perspective view of a third dispenser of the wiping material system for use in the method of the present invention;

FIG. 4 is a schematic perspective view of a fourth dispenser of the wiping material system for use in the method of the present invention, and

FIG. 5 is a flow diagram depicting a questionnaire for use in the method of the present invention.

### DETAILED DESCRIPTION OF PREFERRED EMBODIMENTS

Before describing the attached drawings, it may be useful to familiarize oneself with aspects of the science of colour, i.e. chromatics. As is explained on Wikipedia.org, chromatics includes the perception of colour by the human being, as well as the physics of electromagnetic radiation in the visible range. Electomagnetic radiation is characterized by its wavelength and its intensity. Most light sources emit light at many different wavelengths. A colour may be defined as a class of spectra that give rise to the same colour sensation. In each class the members are called metamers of the colour in question.

The colours of the rainbow include all those colours that can be produced by visible light of a single wavelength only. These colours are known as pure spectral colours and the relevant colours are commonly identified as red, orange, yellow, green, blue and violet. The table below shows the approximate wavelengths (in nanometers) for various pure spectral colours.

| Colour | Wavelength interval |
|---|---|
| Red | ~700-630 nm |
| Orange | ~630-590 nm |
| Yellow | ~590-560 nm |
| Green | ~560-490 nm |
| Blue | ~490-450 nm |
| Violet | ~450-400 nm |

Examples of non-spectral colours are the achromatic colours (black, grey and white) and colours such as pink, tan and magenta.

Ignoring human perception, objects can be said to have the colour of the light leaving their surfaces.

In the drawings, reference number 10 denotes dispensers making up a wiping material system, with each of the dispensers of the system being of a different shape and/or size. Each of the dispensers 10 comprises at least a first component 12 and a second component 14. Typically, these components may be made of a plastics material such as ABS, or a composite material. For high-end applications it is also possible that the dispensers be fabricated from metal. Irrespective of the choice of material, the first and second components 12, 14 are visible to a user when using the dispensers for their intended purpose, i.e. when a user is to remove wiping material from the dispensers. Being visible to a user is meant to include not only components that are opaque or solid but also components that are semi-transparent or smoked. The first component 12 is of a first colour and the second component 14 is of a second colour, with the first and second colours being distinct from each other. The colour of the first component and the colour of the second component are identical for all dispensers 10 of the plurality of dispensers.

For ease of understanding, in each of the drawings the colour of the first component 12 is depicted as shaded, whilst the colour of the second component remains unshaded.

In example embodiments, one of said first and second components is of an achromatic colour, such as black or grey.

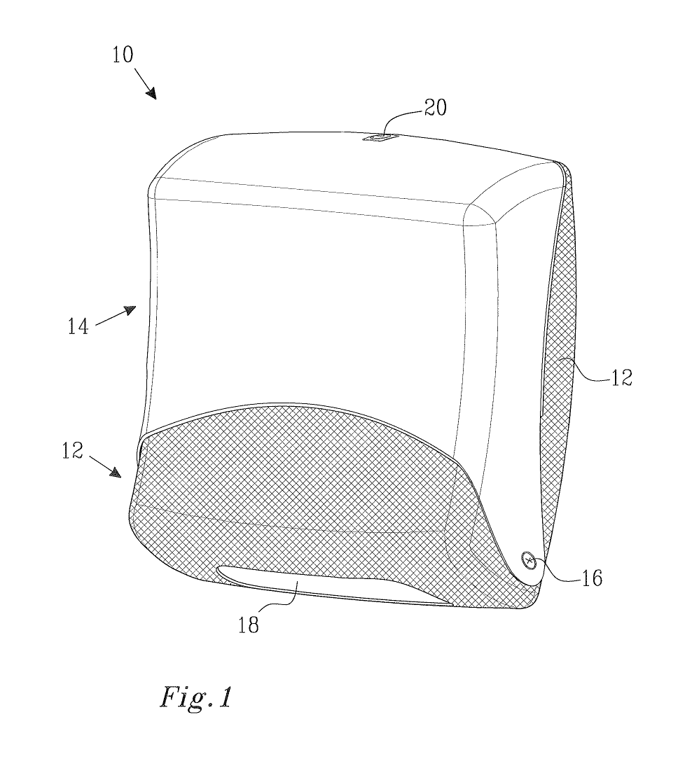

In example embodiments as exemplified in FIGS. 1 to 3, the first component 12 is a 15 base unit adapted to be affixed to a wall and the second component 14 is an access lid of the dispenser. Thus, in FIG. 1, the access lid is arranged to pivot about a substantially horizontally disposed pivot axis 16 arranged on the base unit. The dispenser of FIG. 1 is provided in a known manner in its base unit with a dispensing opening, the location of which is indicated by arrow 18. At a location opposite to the dispensing opening 18, the dispenser may be provided with a lock arrangement 20 to prevent unauthorised access to contents of the dispenser, i.e. wiping material. In the shown embodiment, the lock arrangement is carried on the access lid, though it is to be understood that in other embodiments the lock arrangement may be carried by the base unit. The dispenser of the type illustrated in FIG. 1 is suitable for dispensing wiping material in the form of individual arcs of e.g. paper or nonwoven lying horisontally one on top of the other, i.e. in a stack

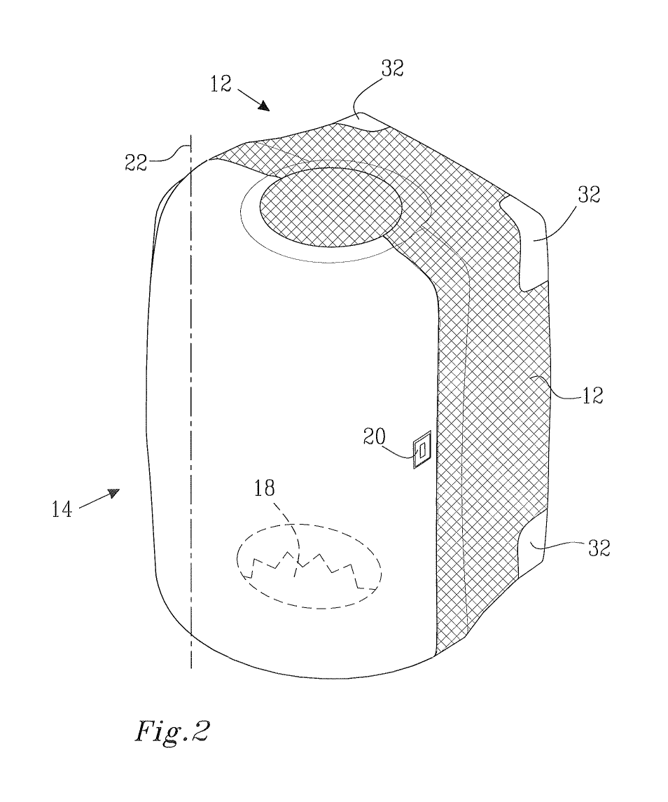

In FIG. 2, the access lid (corresponding to the second component 14) is arranged to pivot about a substantially vertical axis 22 disposed adjacent one side member of the base unit (corresponding to the first component 12). Again, a lock arrangement 20 may be arranged on either the access lid (as illustrated) or on the base unit. The dispenser of FIG. 2 is provided with a dispensing opening in its base unit, the location of which is indicated by arrow 18. The dispenser is intended to be used with rolls of so-called centerfeed paper, i.e. a cylinder of paper arranged with its longitudinal axis in the vertical direction, with the central-most layers of paper being removed from the roll via the dispensing opening. Typically, the dispensing opening is provided with serrations so that a desired amount of paper can be torn off from the roll.

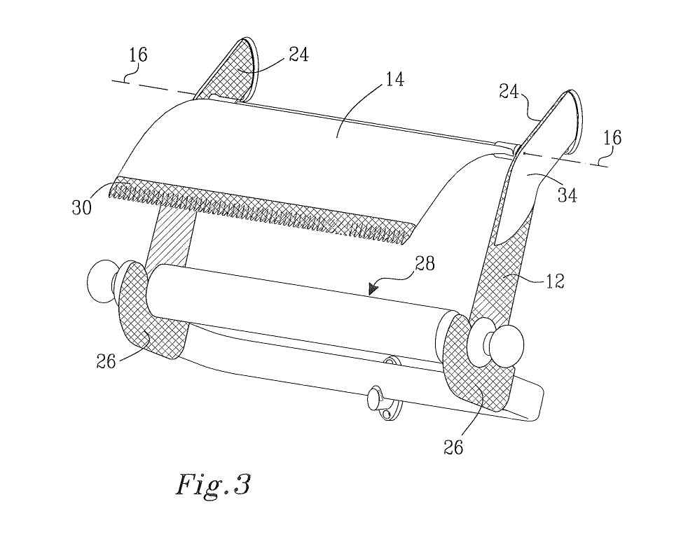

The dispenser illustrated in FIG. 3 is adapted to be affixed to a wall by means of two support arms 24, one of which constituting the first component 12. The support arms 24 are provided with hook-shaped lower ends 26 for supporting an essentially horizontally disposed spindle 28. The spindle is intended to carry a cylindrical roll of wiping material, such as paper or nonwoven. Extending substantially circumferentially around the roll of wiping material is an access lid (corresponding to the second—component 14). The access lid is arranged to pivot about a substantially horizontally disposed pivot axis 16 arranged on the support arms 24. In contrast to centerfeed paper rolls, the wiping material which is carried by the spindle 28 is removed with the outermost layer first. At its end opposite to the pivot axis 16, the access lid is provided with a serration arrangement 30, allowing a desired quantity of wiping material to be torn off from the roll.

In accordance with example embodiments, the first and second components 12, 14 constitute at least 80% of the visible surface(s) of the dispenser. Indeed, in the dispenser illustrated in FIG. 1 the base unit and the access lid make up essentially 100% of the visible surface(s).

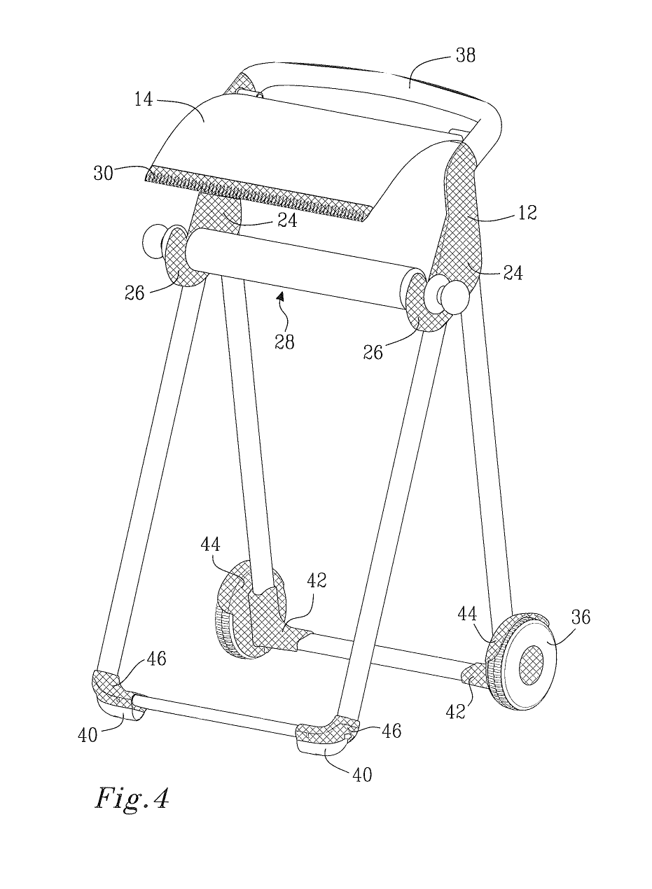

In contrast to the dispensers illustrated in FIGS. 1 to 3, the dispenser of FIG. 4 is intended to stand on a floor. In similarity to the FIG. 3 embodiment, the dispenser of FIG. 4 is intended to dispense wiping material from a roll carried by a substantially horizontally mounted spindle 28, the spindle being supported by hook-shaped lower ends 26 of support arms 24. As with the FIG. 3 embodiment, one of the support arms 24 is constituted by the first component 12 and an access lid pivotally mounted in the same manner as in FIG. 3 is constituted by the second component 14.

As well as being provided with a base unit and an access lid, the dispenser of FIG. 2 also has additional components 32 which are visible to a user. In FIG. 2, these additional components constitute corner pieces affixed to the base unit, i.e. affixed to the first component 12. These additional components may suitably be manufactured from a plastics material or other suitable materials such as rubber. The dispensers of FIGS. 3 and 4 are also provided with additional components such as support arm side pieces 34 in FIG. 3 and wheels 36, a handle 38 and feet 40 in FIG. 4. In accordance with example embodiments, at least one of these additional components 32, 34, 36, 38, 40 has the same colour as the second component 14, i.e. the same colour as the access lid.

In example embodiments, the second component 14 may be of an achromatic colour, such as black or grey. Thus, by way of example, in FIG. 2 the access lid and at least one of the corner pieces are of an achromatic colour.

In example embodiments, at least one of the additional components has the same colour as the first component 12. In such cases, the serration arrangement 30 in FIGS. 3 and 4 may constitute such an additional component. Furthermore, in FIG. 4, the wheels 36 may be carried by corner units 42 and protected by shrouds 44, at least one of which may be deemed to be an additional component having the same colour as the first component 12. In addition, the feet 40 may be carried by feet support 46, also of the same colour as the first component 12.

To provide an easily identifiable appearance, in example embodiments the first component may be of a colour having a wavelength from 450 nm to 670 nm. For example, therefore, the first component may be red and the second component may be a dark grey or black.

A further distinct combination is arrived at by having the first component be white and the second component be turquoise. In such embodiments one or more of the additional components may for example be black.

In example embodiments the first, the second and one or more additional components of the dispensers are arranged such that at least some of the first, the second and any one or more additional components do not lie adjacent a component of the same colour. Thus, in the FIG. 2 embodiment the additional components in the form of one or more of the corner pieces 32 are separated from the access lid by the first component 12 which is of a different colour to the access lid and one or more of the corner pieces. In FIGS. 3 and 4, the serration arrangements 30 are separated from other components of the same colour by the access lid 14.

As mentioned above, the dispensers illustrated in the drawings are suitable for dispensing wiping material which is either stacked, rolled on a centerfeed roll or rolled on a circumferential feed roll. Typically, the wiping material will usually either be made of paper based on cellulose fibres (either virgin or recycled) or made of hydroentangled nonwoven material. In the latter case, the nonwoven material may be composed of a mixture of staple fibres, filaments and pulp fibres. Wiping material refills supplied by the present applicant under the trade name Tork W4 Top Pak may be used together with the dispenser illustrated in FIG. 1. Refills in three different sizes are available for the dispenser of FIG. 2, depending on its dimensions. These refills are available under the trade names M1 Mini Centerfeed Roll, M2 Centerfeed Roll and W2 Combi Roll. Finally, refills for the dispensers illustrated in FIGS. 3 and 4 are available under the trade name W1 Wall Stand/Floor Stand.

It will be apparent from the above that the wiping material system provides a customer with a range of dispensers having a common identity from which the customer can choose depending on the intended application. Irrespective of his choice, the user can be secure in the knowledge that the dispenser will visually pass in with any other dispenser from the wiping material system. Thus, even if a customer needs different wiping material for several different applications, and therefore must acquire several different dispensers, all the dispensers will enjoy a common identity.

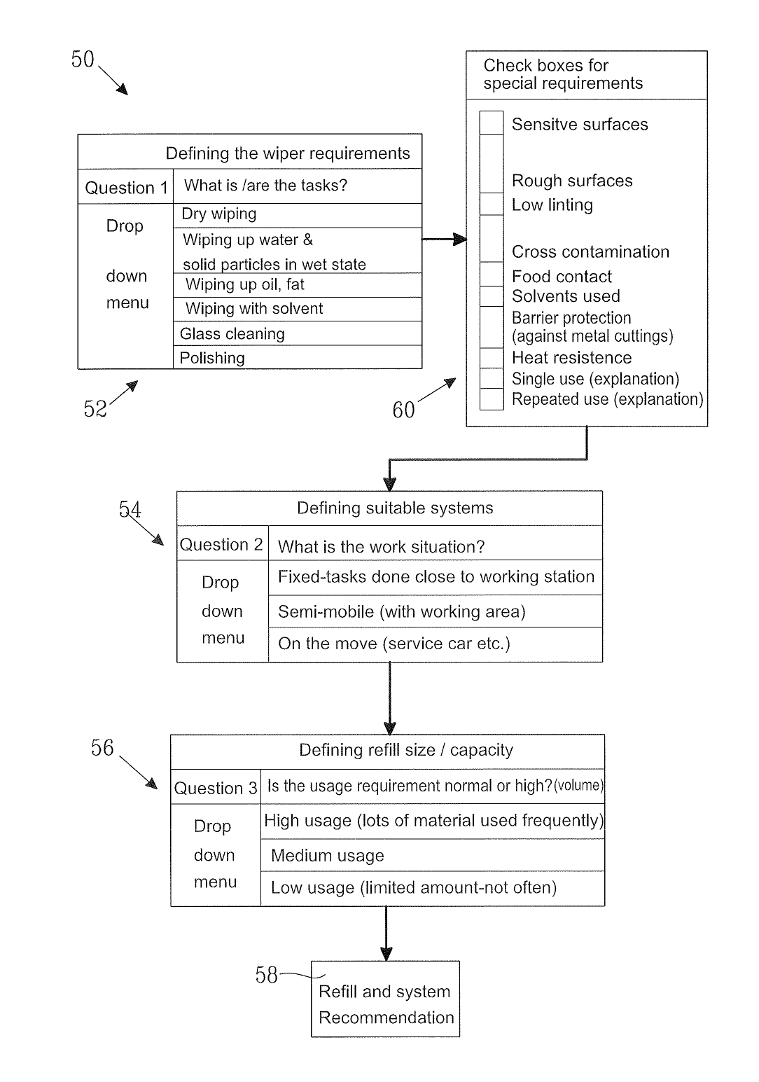

However, the potentially wide range of wiping materials and dispensers can make it difficult for a customer to select the most suitable wiping material and dispenser for a particular purpose. To facilitate this decision-making process, and in accordance with the present invention, a questionnaire is provided. As will be apparent from the following description, the questionnaire is either printed in paper format, such as in a folder, or integrated in software which can be run on a computer such as a PC and/or on line via, for example, the internet. In FIG. 5 reference number 50 generally denotes a questionnaire laid out in the form of a flow diagram. The questionnaire 50 is made up of a plurality of questions denoted by boxes 52, 54, 56. At least one of the questions relates to user requirements of the object-wiping material. Thus, in the illustrated embodiment box 52 is headed “Defining the wiper requirements” and the specific question is: “What is/are the tasks?”. Similarly, box 56 is headed “Defining refill size/capacity” and the specific question is: “Is the usage requirement normal or high (volume)?”. At least a further of the questions relates to the work situation of the user. Thus, in the illustrated embodiment box 54 is headed “Defining suitable systems” and the specific question is: “What is the work situation?”.

For at least one of the questions, though preferably all, the method according to the invention includes providing an exhaustive list of possible answers from which the user is to select at least one. The list may suitably be in the form of a drop-down menu. Examples of possible answers include the following.

To the question “What is/are the tasks”?, the list of possible answers may include “Dry wiping”, “Wiping up water and solid particles in wet state”, “Wiping up oil, fat”, “Wiping with solvent”, “Glass cleaning” and “Polishing”.

To the question “What is the work situation?”, the list of possible answers may include “Fixed—tasks done close to working station”, “Semi-mobile (within working area)” and “On the move (service car, etc.)”.

To the question “Is the usage requirement normal or high? (volume)”, the list of possible answers may include “High usage (lots of material used frequently)”, “Medium usage” and “Low usage (limited amount—not often)”.

Depending on the answers selected, the questionnaire provides a recommendation of the type of object-wiping material and dispenser most suited to that user's needs. This step of the method is depicted by box 58 in FIG. 5.

To further facilitate the identification of suitable object-wiping material and dispenser, the questionnaire may further comprise check boxes with predetermined headings, with the predetermined headings relating to particular user requirements of the object-wiping material. Thus, and as is illustrated in box 60, the predetermined headings may include “Sensitive surfaces”, “Rough surfaces”, “Low linting”, “Cross contamination”, “Food contact”, “Solvents used”, “Barrier protection (against metal cuttings)”, “Heat resistance”, “Single use (explanation)” and “Repeated use (explanation)”.

Using a suitable algorithm, once the user has answered each of the questions and checked any appropriate boxes, a recommendation of the type of object-wiping material and dispenser most suited to that user's needs is provided.

The boxes 52, 54, 56, and 60 as shown in FIG. 5, may come in a different order in the flow diagram. For example, box 60 can be the last in the flow and thus follow box 56, instead of being second in line after box 52.

The dispensers described in relation to FIGS. 1 to 4 are eminently suitable for use in the above-described method.

The invention has been described above by way of example only and the skilled person will appreciate that various modifications may be made within the scope of the invention as defined by the appended claims. For example, the maximum number of colours displayed by the dispensers may be restricted to three or four.

1. A method for facilitating the identification of suitable object-wiping material and dispenser therefor, the method comprising the steps of
providing a questionnaire with a plurality of questions, at least one of said plurality of questions relating to user requirements of the object-wiping material and at least a further of said plurality of questions relating to the work situation of the user;
providing for at least one of said at least one of said plurality of questions and said at least a further of said plurality of questions, an exhaustive list of possible answers from which the user is to select at least one, and
depending on the selected answers, providing a recommendation of the type of object-wiping material and dispenser most suited to that user's needs.

2. The method as claimed in claim 1, wherein said at least one of said plurality of questions relating to user requirements of the object-wiping material relates to the task that the wiping material is to perform.

3. The method as claimed in claim 1, wherein said at least one of said plurality of questions relating to user requirements of the object-wiping material relates to the expected consumption rate of said object-wiping material.

4. The method as claimed in claim 1, wherein said at least a further of said plurality of questions relating to the work situation relates to whether the user performs tasks at a fixed location or whether the tasks are at different locations.

5. The method as claimed in claim 1, wherein said questionnaire further comprises check boxes with predetermined headings, said predetermined headings relating to particular user requirements of the object-wiping material.

6. The method as claimed in claim 1, wherein said method comprises the step of
providing a wiping material system comprising a plurality of dispensers of different shapes and/or sizes, the dispensers each comprising at least a first and a second component, said first and second components being visible to a user, said first component being of a first colour and said second component being of a second colour, said first and second colours being distinct from each other, wherein the colour of said first component and the colour of said second component are identical for all dispensers of said plurality of dispensers, and
said step of providing a recommendation of the type of object-wiping material and dispenser most suited to that user's needs includes recommending one of said plurality of dispensers of said wiping material system.

7. The method as claimed in claim 6, wherein one of said first and second components of each of said dispensers of said plurality of dispensers is of an achromatic colour.

8. The method as claimed in claim 6, wherein said first component is a base unit adapted to be affixed to a wall and said second component is an access lid.

9. The method as claimed in claim 8, wherein said first and second components constitute at least 80% of the visible surface of the dispenser.

10. The method as claimed in claim 6, wherein each dispenser further comprises additional components which are visible to a user, at least one of said additional components having the same colour as said second component.

11. The method as claimed in claim 7, wherein said second component is of an achromatic colour.

12. The method as claimed in claim 10, wherein at least one of said additional components has the same colour as said first component.

13. The method as claimed in claim 6, wherein said first component is of a colour having a wavelength from 450 nm to 670 nm.

14. The method as claimed in claim 6, wherein each dispenser further comprises one or more additional components which are visible to a user,
wherein said first, said second and one or more additional components of the dispensers are arranged such that that at least some of the first, the second and any one or more additional components do not lie adjacent a component of the same colour.

15. The method as claimed in claim 1, wherein the questionnaire is printed in paper format, or integrated in software to enable the method to be run on a computer.

16. The method as claimed in claim 6, wherein said first component is a base unit adapted to be affixed to a wall and said second component is an access lid,
wherein said first and second components constitute at least 80% of the visible surface of the dispenser,
wherein each dispenser further comprises one or more additional components which are visible to a user,
wherein said first, said second and one or more additional components of the dispensers are arranged such that the first, the second and the one or more additional components do not lie adjacent a component of the same colour.
